(19) United States
(12) Patent Application Publication
(10) Pub. No.: US 2020/0336885 A1
(43) Pub. Date: Oct. 22, 2020

(54) SUPPORT FOR EMERGENCY SERVICES

(71) Applicant: TELEFONAKTIEBOLAGET LM ERICSSON (PUBL), Stockholm (SE)

(72) Inventors: Paul SCHLIWA-BERTLING, LJUNGSBRO (SE); Gunnar MILDH, SOLLENTUNA (SE); Shabnam SULTANA, Montreal (CA)

(73) Assignee: TELEFONAKTIEBOLAGET LM ERICSSON (PUBL), Stockholm (SE)

(21) Appl. No.: 16/763,505

(22) PCT Filed: Nov. 13, 2018
(86) PCT No.: PCT/IB2018/058926

§ 371 Date: May 12, 2020

Related U.S. Application Data
(60) Provisional application No. 62/585,244, filed on Nov. 13, 2017.

(51) Int. Cl. H04W 4/90; H04W 4/12; H04W 4/06; H04W 60/00; H04L 29/06; H04W 76/25

(52) U.S. Cl. CPC H04W 4/90; H04W 4/12; H04W 4/06; H04W 84/042; H04L 65/1016; H04W 76/25; H04W 60/00

(57) ABSTRACT

Method relating to a wireless device, WD, connecting to a first core network/system, such as 5GC/5GS that does not support Emergency Services, ES, obtains information for performing ES with another core network/system is provided. The method comprises the WD receiving from the first core network/system a message comprising ES information indicating that at least one of one or more other core network/system or one or more radio access node capable of connecting to one or more other core network/system, such as EPC/EPS, all able to support ES and is in the same Public Land Mobile Network, PLMN, as the first core network/system or belong to other PLMN. The method further comprises sending to the other core network/system, in accordance with the received ES information, a connection request indicating ES. A method on a network entity providing the ES information to the wireless device is also provided.

### RELATED APPLICATION

This application claims the benefit of provisional patent application Ser. No. 62/585244, filed Nov. 13, 2017, the disclosure of which is hereby incorporated herein by reference in its entirety.

### TECHNICAL FIELD

This disclosure relates generally to fallback mechanism of emergency services and multi system environment, 4G and 5G.

### BACKGROUND

The 5G system defined by Third Generation Partnership Project, 3GPP in Release 15 includes both a new radio access (NR) and a new Core Network (Fifth Generation Core, 5GC). The 5GC offers several new features such as support for network slicing, improved QoS, and latency and battery optimizations in the form of a new User equipment/wireless device, UE, state called inactive mode. To be able to provide these features also in Long Term Evolution, LTE, or fourth generation, 4G, or Evolved Universal Terrestrial Radio access, E-UTRA (all referring to the same radio), the LTE evolved Node B, eNB, needs to support connectivity to 5GC. Together the LTE eNBs and NR base stations, gNBs connected to 5GC make up the next generation radio access network (NG-RAN).

3GPP decided that a NR and E-UTRA/LTE can provide access to 5GC. It is also agreed that a cell providing access using E-UTRA can provide access via EPC as well as 5GC. This means that such cell can be serving UEs connected to either core networks and thus provide the respective services. Furthermore, support for Emergency Services, ES, might be limited to only some systems, e.g. 2G or 3G and there need to be efficient mechanisms in place providing access to ES to users/UEs being currently served by a system that does not provide ES itself.

Currently in E-UTRA/LTE, the network may broadcast support for Internet Multimedia Subsystem, IMS, emergency call in SystemInformationBlockType1 (SIB1) sent over the radio interface as shown in bold/underlined in the ASN of SIB Type 1 of Table 1 below as specified in 3GPP TS 36.331. It will be appreciated that many information elements of SIB Type 1 are not shown for simplicity.

SystemInformationBlockType1 message

-- ASN1START

| | |
|---|---|
| SystemInformationBlockType1-BR-r13 ::= | SystemInformationBlockType1 |

| | |
|---|---|
| SystemInformationBlockType1 ::= | SEQUENCE { |

| cellAccessRelatedInfo | SEQUENCE { | |
|---|---|---|
| plmn-IdentityList | PLMN-IdentityList, | |
| trackingAreaCode | TrackingAreaCode, | |
| cellIdentity | CellIdentity, | |
| cellBarred | ENUMERATED {barred, notBarred}, | |
| intraFreqReselection | ENUMERATED {allowed, notAlowed}, | |
| csg-Indication | BOOLEAN, | |
| csg-Identity | CSG-Identity | OPTIONAL -- |

Need OR
},

| cellSelectionInfo | SEQUENCE { | |
|---|---|---|
| q-RxLevMin | Q-RxLevMin, | |
| q-RxLevMinOffset | INTEGER (1..8) | OPTIONAL -- |

Need OP
},

| | | |
|---|---|---|
| p-Max | P-Max | OPTIONAL, |

-- Need OP

| freqBandIndicator | FreqBandIndicator, | |
|---|---|---|
| schedulingInfoList | SchedulingInfoList, | |
| tdd-Config | TDD-Config | OPTIONAL, -- |

Cond TDD

| si-WindowLength | ENUMERATED { |
|---|---|
| | ms1, ms2, ms5, ms10, ms15, ms20, |
| | ms40}, |
| systemInfoValueTag | INTEGER (0..31), |
| nonCriticalExtension | SystemInformationBlockType1-v890-IEs |

OPTIONAL
}

| | |
|---|---|
| SystemInformationBlockType1-v890-IEs::= | SEQUENCE { |
| lateNonCriticalExtension | OCTET STRING (CONTAINING |
| SystemInformationBlockType1-v8h0-IEs) | OPTIONAL, |
| nonCriticalExtension | SystemInformationBlockType1-v920-IEs |

OPTIONAL
}
-- Late non critical extensions

| SystemInformationBlockType1-v8h0-IEs ::= | SEQUENCE { | |
|---|---|---|
| multiBandInfoList | MultiBandInfoList OPTIONAL, | -- Need |

OR

| | |
|---|---|
| nonCriticalExtension | SystemInformationBlockType1-v9e0-IEs |

OPTIONAL
}

| SystemInformationBlockType1-v9e0-IEs ::= | SEQUENCE { | |
|---|---|---|
| freqBandIndicator-v9e0 | FreqBandIndicator-v9e0 | OPTIONAL, -- |

Cond FBI-max

| | | |
|---|---|---|
| multiBandInfoList-v9e0 | MultiBandInfoList-v9e0 | OPTIONAL, -- |

Cond mFBI-max

| | |
|---|---|
| nonCriticalExtension | SystemInformationBlockType1-v10j0-IEs |

OPTIONAL
}
SystemInformationBlockType1-v10j0-IEs ::= SEQUENCE {

| | | |
|---|---|---|
| freqBandInfo-r10 | NS-PmaxList-r10 | OPTIONAL, -- |

Need OR

| | | |
|---|---|---|
| multiBandInfoList-v10j0 | MultiBandInfoList-v10j0 | OPTIONAL, -- |

Need OR

| | |
|---|---|
| nonCriticalExtension | SystemInformationBlockType1-v1010-IEs |

OPTIONAL
}
SystemInformationBlockType1-v1010-IEs ::= SEQUENCE {

| | | |
|---|---|---|
| freqBandInfo-v1010 | NS-PmaxList-v1010 | OPTIONAL, -- |

Need OR

| | | |
|---|---|---|
| multiBandInfoList-v1010 | MultiBandInfoList-v1010 | OPTIONAL, -- |

Need OR

| | | |
|---|---|---|
| nonCriticalExtension | SEQUENCE { } | OPTIONAL |

}
-- Regular non critical extensions

| SystemInformationBlockType1-v920-IEs ::= | SEQUENCE { | |
|---|---|---|
| ims-EmergencySupport-r9 | ENUMERATED {true | OPTIONAL, -- |

Need OR

| | | |
|---|---|---|
| cellSelectionInfo-v920 | CellSelectionInfo-v920 | OPTIONAL, -- |

Cond RSRQ

| | |
|---|---|
| nonCritialExtension | SystemInformationBlockType1-v1130-IEs |

```
  OPTIONAL
}
    [...]
```

TABLE 1
SystemInformationBlockType1 field descriptions

[ . . . ]
ims-EmergencySupport
Indicates whether the cell supports IMS emergency bearer services for UEs in limited service mode.
If absent, IMS emergency call is not supported by the network in the cell for UEs in limited service
mode. NOTE 2.

The indication “ims-EmergencySupport-r9” however only indicate if the E-UTRAN/EPC system (EPS) support emergency call support using limited service mode. Limited service mode is for instance used when the UE does not have a valid subscription or a valid (Universal) Subscription Identity Module, (U)SIM (for more details on Limited Service state see 3GPP TS 23.401). In case the UE has a valid subscription (U)SIM emergency calls can (and should) instead be supported in Basic service mode. Basic service mode support additional features such as subscriber identification, emergency call back etc. Support for basic service mode is not broadcasted, instead the UE need to connect (or attach) to the EPS, as per FIG. 5.3.2.1-1 from 3GPP TS 23.401, simplified in FIG. 1B (prior art) to determine if ES is supported.

### SUMMARY

Embodiments are presented herein to enable a multi-access wireless device or user equipment to access emergency services, ES, quicker in a multi-system environment where emergency services is only provided over a portion of the multi-system environment. The wireless device or user equipment supports the fifth generation, 5G, radio access technology, but supports also other radio access technology such as 4G long Term Evolution, Wireless local Area Network, WLAN or other.

In accordance with some embodiments, a wireless device attempts to register with the 5G system (NG-RAN and 5G Core, 5GC) or with the IP Multimedia Subsystem, IMS over the 5G system. However, the 5G system as accessed by the wireless device, does not support ES. The wireless device is thus instructed by the 5G system (either 5GC or NG-RAN) and may be IMS to fallback to a different core network, such as Evolved Packet Core, EPC, or system, such as EPS where the EPS comprises at least one LTE eNB connected to an EPC. The wireless device would then fallback to a radio access node connected to EPC.

In accordance with one aspect, a method of obtaining emergency service, ES, by a wireless device connecting to a first core network or to a system that does not support ES is provided. The method comprises the step of receiving from a first core network or system, which may be a 5G Core network, 5GC or 5G System, 5GS, a message comprising ES information indicating that at least one of one or more other core network or system or one or more radio access node capable of connecting to one or more other core network or system, such as 4G EP or EPS, and where the other core network or system or radio access node connected to other core network is able to support ES and the at least one or more other core network or system or the one or more radio access node is in the same Public Land Mobile Network, PLMN, as the first core network or system or belong to one or more other PLMN. The method further comprises the step of using the received information for sending, when needed, a connection request indicating ES to the at least one of the one or more other core network or system or one of the one or more radio access node as selected by the wireless device.

In accordance with another aspect, the at least one of the one or more other core network or system or the one or more radio access node is provided in an ordered priority to the wireless device/UE.

In accordance with another aspect, the radio access node is either a 5G radio access node, gNB, or a Long-Term Evolution radio access node, or eNB, or a non-third generation partnership, non-3GPP, access (such as a WLAN) node.

In one aspect the message received by the wireless device/UE is is a broadcast 5G system information if the wireless device/UE is connected to a gNB, or a broadcast Long-Term Evolution, LTE, system information block type 1, if the UE is connected to an eNB connected to 5GC for example or the message may be a Non-Access Stratum, NAS, message received from the 5GC. Furthermore, the message may also be a Session Initiation Protocol, SIP, from the Internet Protocol Multimedia Subsystem, IMS, message such as an IMS registration or an IMS INVITE message.

In accordance with an aspect, a method of controlling access of a wireless device for Emergency Services, ES, performed at a network entity in a first core network or system such as 5GC or 5GS that does not support ES is provided. The method comprises the step of determining for the wireless device at least one of one or more other core network or system, such as 4G EPC or EPS or one or more radio access node capable of connecting to one or more other core network, Where the radio access node may be a 3GPP node or a node in non-3GPP access. The one or more other core network or system, or one or more radio access node capable of connecting to one or more other core network is able to support ES and is in the same Public Land Mobile Network, PLMN, as the first core network or system or in one or more other PLMN. The method further comprises the step of sending to the wireless device a message comprising ES information indicating that ES is provided by the at least one of the one or more other core network or system or the one or more radio access node capable of connecting to one or more other core network.

In accordance with another aspect, the at least one or more other core network or system is provided in an ordered priority.

In accordance with another aspect, the message transmitted to the wireless device/UE is a broadcast 5G system information or a broadcast Long Term Evolution, LTE, system information block type 1 or a Non-Access Stratum, NAS message or an IMS message such as an IMS registration or an IMS INVITE message

In accordance with another aspect the network entity may be a Access Mobility

Function, AMF of the 5GC, a gNB connected to the 5GC, an eNB connected to the 5GC, an IMS Call Session Control Function, CSCF.

In accordance with an aspect, a computer program comprising instructions which, when executed on at least one processor, cause the at least one processor to carry out any of the embodiments herein. In another aspect, a carrier containing the computer program wherein the carrier is one of an electronic signal, an optical signal, a radio signal, or a computer readable storage medium

In accordance with another aspect, a wireless device comprising a processing circuitry configured to perform any of the embodiments herein and a power supply circuitry configured to supply power to the wireless device.

In accordance with yet another aspect, a user equipment, UE, comprises an antenna configured to send and receive wireless signals, a radio front-end circuitry connected to the antenna and to processing circuitry, and configured to condition signals communicated between the antenna and the processing circuitry, the processing circuitry being configured to perform any of embodiments herein. In addition, the UE comprises an input interface connected to the processing circuitry and configured to allow input of information into the UE to be processed by the processing circuitry, an output interface connected to the processing circuitry and configured to output information from the UE that has been processed by the processing circuitry and a battery connected to the processing circuitry and configured to supply power to the UE.

In accordance with another aspect, a wireless device/UE comprises a network interface, one or more processors and memory comprising instructions executable by the one or more processors whereby the wireless device is operable to perform any of the method embodiments herein.

In accordance with another aspect, a wireless device comprises a receiving module operable to receive from a first core network or system a message comprising Emergency Service, ES, information indicating at least one of one or more other core network or system or one or more radio access node capable of connecting to one or more other core network that is able to support ES, wherein the at least one or more other core network or system or the one or more radio access node is in the same Public Land Mobile Network, PLMN, as the first core network or system or belong to one or more other PLMN. The wireless device further comprises a determining module operable to, based on the ES information, determine a core network or system or radio access node to send a connection request indicating ES.

In accordance with another aspect, a network entity for controlling access of a wireless device for Emergency Services, ES, comprises a network interface, one or more processors and memory comprising instructions executable by the one or more processors whereby the network entity is operable to perform any of the method steps described herein.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

The accompanying drawing figures incorporated in and forming a part of this specification illustrate several aspects of the disclosure, and together with the description serves to explain the principles of the disclosure.

FIG. 1A (prior art) illustrates a 5G System and a 4G system comprising a Core network and access network as accessed by a UE.

FIG. 1B (prior art) illustrates an attach procedure as described in 3GPP TS 23.401.

FIG. 2 illustrates example of systems in which embodiments herein may be implemented.

FIG. 3 is a schematic block diagram illustrating a virtualization environment in which functions implemented by some embodiments may be virtualized.

FIG. 4 illustrates a method in a wireless device or User equipment, UE, of accessing emergency service, ES, according to an embodiment.

FIG. 5 illustrates a method in a network entity that does not support ES and indicating to the UE where to obtain the ES according to some embodiments.

FIG. 6 illustrates a circuitry of a wireless device or UE according to an embodiment.

FIG. 7 illustrates a circuitry of a wireless device or UE according to another embodiment.

FIG. 8 illustrates a circuitry of a network entity, according to an embodiment.

FIG. 9 illustrates a circuitry of a network entity, according to another embodiment.

### DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Generally, all terms used herein are to be interpreted according to their ordinary meaning in the relevant technical field, unless a different meaning is clearly given and/or is implied from the context in which it is used. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Currently, a UE may be registered to 5G Core Network (5GC) (via LTE or NR or other RAT such WLAN) that does not support Emergency Services (ES) (it could either due to that the current RAT does not support ES or that all RATs providing connection to 5GC do not support ES). The information indicating that ES is not supported is assumed to be communicated to the UE at registration procedure with the 5GC. Therefore, the UE may attempt to obtain ES from another system, e.g. EPS, by accessing the network/EPS via a cell using E-UTRA that provides access to EPC, assuming the EPC supports ES.

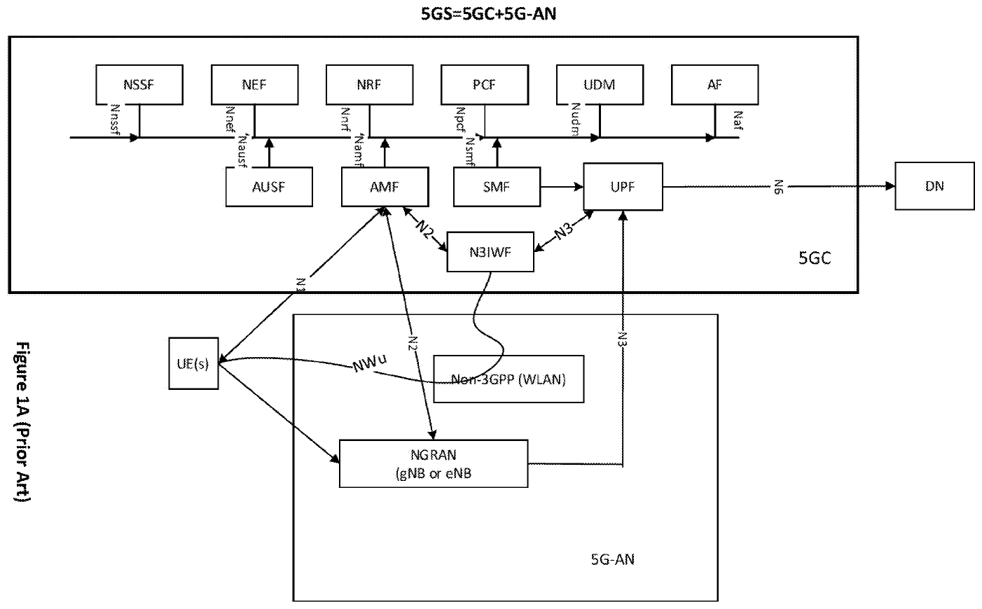

To become aware of whether ES (in the preferred basic service mode) is supported by the EPC, the UE must perform registration procedure with the EPC first as shown in FIG. 1 (prior art). During this procedure, the UE receives an indication from the network indicating that basic service mode is supported via Non-Access Stratum, NAS, message comprising Emergency Service support indication and Voice over IMS, VoIMS support indication. The indications are further described in 3GPP TS 23.401 (clauses 4.3.5.8 and 4.3.12) and 3GPP TS 23.167. Only the relevant steps of the current Attach procedure as specified in 3GPP TS 23.401 clause 5.3.2.1 are illustrated in FIG. 1B (prior art) and described herein.

1. A UE, camping on an E-UTRAN cell reads the related System Information Broadcast.

If the UE can proceed to attach, it initiates the Attach procedure by the transmission, to the eNodeB, of an Attach Request (IMSI or old GUTI, Old GUTI type, last visited TAI (if available), UE Core Network Capability, UE Specific DRX parameters, extended idle mode DRX parameters, Attach Type, ESM message container (Request Type, PDN Type, Protocol Configuration Options, Ciphered Options Transfer Flag, Header Compression Configuration), KSIASME, NAS sequence number, NAS-MAC, additional GUTI, P-TMSI signature, Voice domain preference and UE's usage setting, Preferred Network behaviour, MS Network Capability, Support for restriction of use of Enhanced Coverage) message together with RRC parameters indicating the Selected Network and the old GUMMEI.

Attach Type indicates whether it is an EPS attach or a combined EPS/IMSI attach or an

Emergency Attach. Emergency Attach shall not be indicated when the UE is using NB-IoT. When using C-IoT EPS optimisations, the UE may indicate EPS attach and request SMS by setting the “SMS transfer without Combined Attach” flag in the Preferred Network Behaviour IE.

17.

For emergency attach the MME determines the UE-AMBR to be used by the eNodeB from the APN AMBR received from the S-GW.

If new MME hasn't received, from Step 12, Voice Support Match Indicator for the UE from the eNB then, based on implementation, the MME may set IMS Voice over PS session supported Indication and update it at a later stage.

The new MME sends an Attach Accept (GUTI, TAI List, Session Management Request (APN, PDN Type, PDN Address, EPS Bearer Identity, Protocol Configuration Options, Header Compression Configuration, Control Plane Only Indicator), NAS sequence number, NAS-MAC IMS Voice over PS session supported Indication, Emergency Service Support indicator LCS Support Indication, Supported Network Behaviour) message to the eNodeB. GUTI is included if the new MME allocates a new GUTI. PDN Type and PDN Address are omitted if the Attach Request (step 1) did not contain an ESM message container.

If the attach type is not set to “Emergency”, and the ESM container was included in Attach Request in step 1, and the UE indicated support of Attach without PDN Connection in the Attach Request, and the MME supports Attach without PDN Connection, and PDN connection restriction is set in subscriber data, then the MME shall discard the ESM container in the Attach Request message, and shall not include PDN related parameters in the Attach Accept, but may include CSG related information.

For an emergency attached UE, i.e. for UEs that have only emergency EPS bearers established, there is no AS security context information included in the 51 control messages and there is no NAS level security when the UE cannot be authenticated. The Emergency Service Support indicator informs the UE that Emergency bearer services are supported, i.e. the UE is allowed to request PDN connectivity for emergency services.

18. If the eNodeB received an S1-AP Initial Context Setup Request the eNodeB sends the RRC Connection Reconfiguration message including the EPS Radio Bearer Identity to the UE, and the Attach Accept message will be sent along to the UE.

Given that a registration procedure requires a number of messages being exchanged between the UE and the EPS, access to the ES may be delayed as the UE may further be redirected from EPC to another network if the EPC does not support ES, further delaying access to ES. The latency to obtain ES is crucial and thus current solution is not optimal and embodiments describing redirecting the UE as soon as possible to a network/system that supports ES are presented.

To mitigate the delay to access to Emergency services in a multi-system environment, i.e., an environment that supports multiple accesses and multiple core networks, methods and apparatus are provided describing a UE connected or connecting/registering to the 5GC/5GS and where the 5GC/5GS provides the UE (or wireless device) with information indicating that ES is not supported by the 5GC/5G system, and that different core network or system or cell (i.e., radio access node), such as EPC/EPS or eNB respectively in the same PLMN or other PLMN supports ES. The UE then when it needs to send an emergency request, would use the information provided by the 5GC/5GS and fallback to the different core network/system/cell (or radio access node).

A 5GS herein comprises a 5GC and a 5G RAN as accessed by the UE. In this specification, when 5GS does not support ES, it corresponds to ES not being supported by either the 5GC, or by the NG-RAN accessed by the UE (i.e., the Radio Access Node connected to the 5GC) or both. See FIG. 1A for an illustration of a system in 5G and 4G, i.e., 5GS and 4GS respectively as accessed by the UE.

When ES is not supported by 5GC/5GS, the latter suggests or instructs the UE that it should connect to other core network/system/cell such as EPC/EPS/cell represented by for example an eNB, in order to receive Emergency Service. The information about the Core network/system that supports ES is provided to the UE while the UE is connected to 5GC to avoid the need for the UE to look and connect to yet another Core network/system or cell that does not support ES, when it needs to send an Emergency request.

The information provided to the UE from the 5GC/5G System relates to Emergency services, ES, in basic mode (i.e., not in limited mode).

Several embodiments describing how the 5GC/5G system provides the information to the UE including how the UE uses the received information to trigger an emergency request are provided.

In one aspect, support for Emergency Services in EPC is broadcasted and indicated in the system information. Example
it could be provided on NR system info broadcast channel,
or on LTE system info broadcast channel for LTE cells that support 5GC;
   The information will be read by 5GC capable UEs

In another aspect, support for Emergency Services in EPC is provided to UEs connected to 5GC using dedicated signaling. Example:
it is provided over 5G on NAS level e.g. during 5G NAS registration
it is provided using IMS signaling over 5G.
it is provided on RRC level e.g. when UE request ES fallback, or at initial RRC connection setup.

It is important to note that an indication of Emergency Service support over EPC may be provided via various means to the UE. As the UE accesses the EPC over NAS and accesses the 5GC over N1 which is a 5G version of NAS, the indication for the UE to use EPC/EPS for ES may be an indication to use EPC NAS for emergency services (instead of 5G NAS, i.e., N1). Furthermore, as indicated, the UE may be connected to 5GC via LTE eNB or 5G gNB. Therefore, if the 5GC does not support ES and the UE is connected via the LTE eNB to 5GC, and the LTE eNB supports ES, the 5GC may simply indicate that EPC be used, i.e., UE should use EPC NAS to receive ES over the eNB connected to the EPC. If however, the eNB connected to the 5GC cannot connect to EPC, then a new eNB should be used.

If both the 5GC and the base station (eNB or gNB) used by the UE do not support

ES, or the UE accessed the 5GC from a non-3GPP access network (e.g., WLAN) and the 5GC does not support ES, the ES information to the UE should indicate fallback to an EPS, i.e., indicates that the UE uses a different base station in the 3GPP access network, i.e., an eNB connected to an EPC. Again, the indication that EPC be used corresponds to an indication of using EPC based NAS.

The UE then uses the obtained ES information about fallback to another Core network or system that supports ES to trigger Emergency request to obtain access to emergency services. The core network or system is of the same PLMN as the 5GS or from another PLMN. The core network or system may be an EPC or EPS.

If there is no EPC/EPS that supports ES, the UE can fallback to another network that supports ES such as 2G, 3G network, in which case
the UE will search for other RAT technologies supporting ES, e.g. UTRAN or GSM.
The UE may also obtain the information about the frequencies of other RATs (e.g. 2G CS, 3G CS) that are candidate to provide ES based on the information provided in the 5G system information.

The embodiments presented herein provide the UE with network assistance to obtain fast access to Emergency Services requiring fallback from 5G system to another system, e.g. EPS, or 2G or 3G because ES is not supported by the 5G system. The information is provided to the UE while the UE is connected to 5GC over a 3GPP radio access network such as eNB or gNB or over a non-3GPP access network such as WLAN, to help the UE connect to a system capable of providing ES without further redirection or fallbacks.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

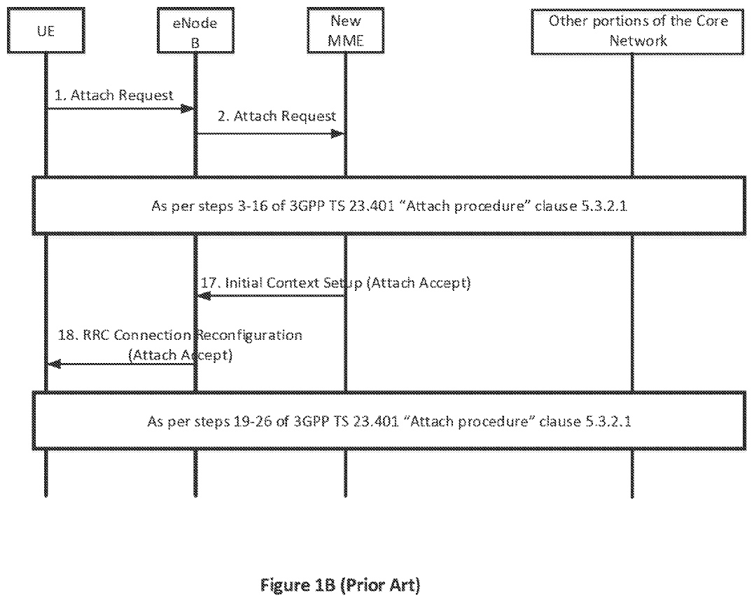

Although the subject matter described herein may be implemented in any appropriate type of system using any suitable components, the embodiments disclosed herein are described in relation to a wireless network, such as the example wireless network illustrated in FIG. 2. For simplicity, the wireless network of FIG. 2 depicts network 106 (e.g., 5GC), Network 106b (EPC), Network node 160 in NG-RAN, and wireless devices, WDs 110, 110b, and 110c also referred above to as UEs. If NG-RAN is an LTE eNB it may be able to connect to network 106, 5GC, and/or to Network 106b, such as an Evolved Packet Core, EPC. FIG. 2 illustrates a network node 160 that connects only to a 5GC network 106. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards.

Network 106 is illustrated as a 5GC network that is connected to the WD 110 over the 5GC-NAS interface, known as the N1 interface via the network node 160.

Network 106b is illustrated as an EPC network that is connected to the WD 110 over the EPC-NAS interface, via the network node 160 in which case the NG-RAN is or comprises an LTE eNB.

Network node 160 and WD 110 comprise various components described in more detail below. These components work together in order to provide network node and/or wireless device functionality such as providing wireless connections or wireless access to a wireless network.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 2, network node 160 includes processing circuitry 170, device readable medium 180, interface 190, auxiliary equipment 184, power source 186, power circuitry 187, and antenna 162. Although network node 160 illustrated in the example wireless network of FIG. 2 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs) such as LTE and NR. In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, LTE, NR, WiFi wireless technologies. These wireless technologies may be integrated into the same or different chip or set of chips and other components within network node 160.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

As used herein, wireless device (WD) refers to a device capable, configured, arranged and/or operable to communicate wirelessly with network nodes and/or other wireless devices. Embodiments herein are described for a WD supporting access to 5GC via NR or LTE and supporting access to EPC using LTE but it may be applicable to any situation where the WD supports a specific CN type, such as WLAN, UTRAN or GPRS. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, LTE, NR, WiFi wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated in FIG. 2, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

Still as illustrated in FIG. 2, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

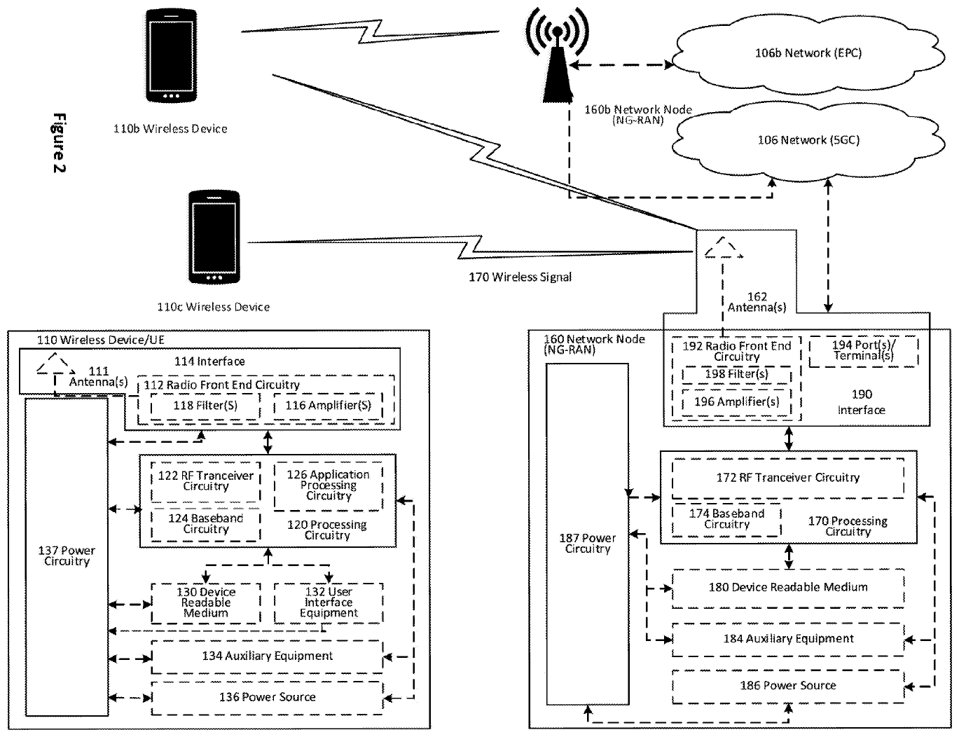

FIG. 3 is a schematic block diagram illustrating a virtualization environment 200 in which functions implemented by some embodiments may be virtualized. In the present context, virtualizing means creating virtual versions of apparatuses or devices which may include virtualizing hardware platforms, storage devices and networking resources. As used herein, virtualization can be applied to a network node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 200 hosted by one or more of hardware nodes 230. Further, in embodiments in which the virtual node is not a radio access node or does not require radio connectivity (e.g., a Core Network node), then the network node may be entirely virtualized.

The functions may be implemented by one or more applications 220 (which may alternatively be called software instances, virtual appliances, network functions, virtual nodes, virtual network functions, etc.) operative to implement some of the features, functions, and/or benefits of some of the embodiments disclosed herein. Applications 220 are run in virtualization environment 200 which provides hardware 230 comprising processing circuitry 260 and memory 290. Memory 290 contains instructions 295 executable by processing circuitry 260 whereby application 220 is operative to provide one or more of the features, benefits, and/or functions disclosed herein.

Virtualization environment 200, comprises general-purpose or special-purpose network hardware devices 230 comprising a set of one or more processors or processing circuitry 260, which may be commercial off-the-shelf (COTS) processors, dedicated Application Specific Integrated Circuits (ASICs), or any other type of processing circuitry including digital or analog hardware components or special purpose processors. Each hardware device may comprise memory 290-1 which may be non-persistent memory for temporarily storing instructions 295 or software executed by processing circuitry 260. Each hardware device may comprise one or more network interface controllers (NICs) 270, also known as network interface cards, which include physical network interface 280. Each hardware device may also include non-transitory, persistent, machine-readable storage media 290-2 having stored therein software 295 and/or instructions executable by processing circuitry 260. Software 295 may include any type of software including software for instantiating one or more virtualization layers 250 (also referred to as hypervisors), software to execute virtual machines 240 as well as software allowing it to execute functions, features and/or benefits described in relation with some embodiments described herein.

Virtual machines 240, comprise virtual processing, virtual memory, virtual networking or interface and virtual storage, and may be run by a corresponding virtualization layer 250 or hypervisor. Different embodiments of the instance of virtual appliance 220 may be implemented on one or more of virtual machines 240, and the implementations may be made in different ways.

During operation, processing circuitry 260 executes software 295 to instantiate the hypervisor or virtualization layer 250, which may sometimes be referred to as a virtual machine monitor (VMM). Virtualization layer 250 may present a virtual operating platform that appears like networking hardware to virtual machine 240.

As shown in FIG. 3, hardware 230 may be a standalone network node with generic or specific components. Hardware 230 may comprise antenna 2225 and may implement some functions via virtualization. Alternatively, hardware 230 may be part of a larger cluster of hardware (e.g. such as in a data center or customer premise equipment (CPE)) where many hardware nodes work together and are managed via management and orchestration (MANO) 2100, which, among others, oversees lifecycle management of applications 220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 240 may be a software implementation of a physical machine that runs programs as if they were executing on a physical, non-virtualized machine. Each of virtual machines 240, and that part of hardware 230 that executes that virtual machine, be it hardware dedicated to that virtual machine and/or hardware shared by that virtual machine with others of the virtual machines 240, forms a separate virtual network elements (VNE).

Still in the context of NFV, Virtual Network Function (VNF) is responsible for handling specific network functions that run in one or more virtual machines 240 on top of hardware networking infrastructure 230 and corresponds to application 220 in FIG. 3.

In some embodiments, one or more radio units 2200 that each include one or more transmitters 2220 and one or more receivers 2210 may be coupled to one or more antennas 2225. Radio units 2200 may communicate directly with hardware nodes 230 via one or more appropriate network interfaces and may be used in combination with the virtual components to provide a virtual node with radio capabilities, such as a radio access node or a base station.

In some embodiments, some signalling can be effected with the use of control system 2230 which may alternatively be used for communication between the hardware nodes 230 and radio units 2200.

Following are detailed description of the embodiments using the wireless devices (UE), network nodes, networks described herein.

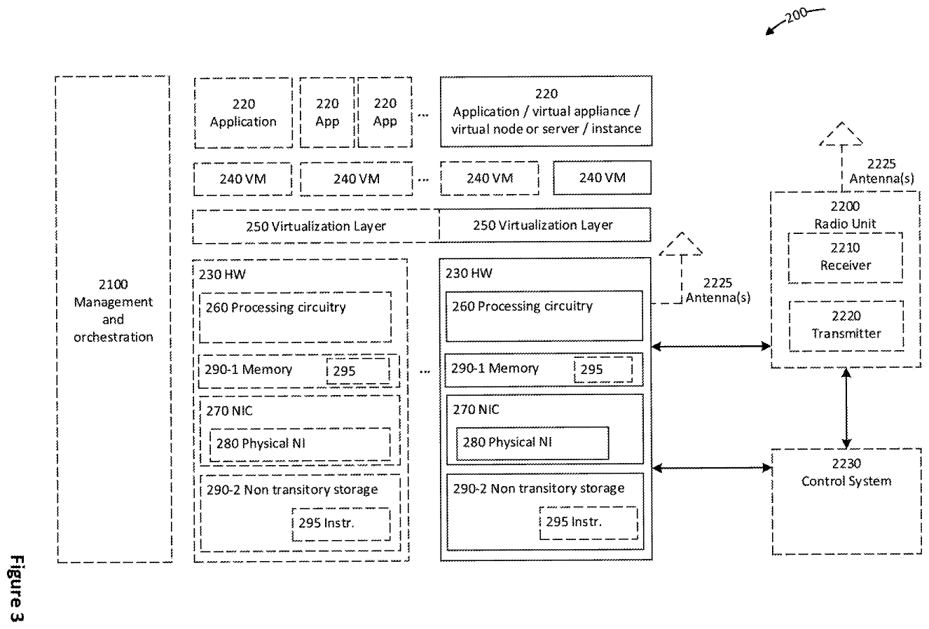

FIG. 4 illustrates a method performed by a UE connected or connecting to a first network, such as 5GC using NG-RAN which may be gNB or eNB in accordance with an embodiment.

Step 400: The UE is connected or connecting to 5GC over NG RAN, where NG

RAN comprises at least one of 5G access nodes (gNBs), 4G access nodes (eNBs). The UE performs the step 400 of obtaining ES information from 5GC/system indicating for the UE to connect to another network that supports ES, and the information includes information about the network/system that supports ES and where the information is obtained from a broadcast signaling over a broadcast channel or from a dedicated signaling. Note that as indicated previously, a system herein refers to a core network in combination with the supported access network(s), e.g., Evolve Packet System, EPS, comprises EPC and E-UTRAN and may comprise a Non-3GPP access network. A 5G System, 5GS, comprises a 5G Core, 5GC and a 5G access network, such as NG-RAN, consisting of 3GPP radio access nodes, and may also comprise Non 3GPP access network, such as WLAN.

Broadcast signaling over a broadcast channel may comprise:
System information broadcasted from the gNB system information broadcast channel, if the UE is connected to 5GC over gNB, or
System information on LTE system info broadcast channel for LTE cells that support 5GC (the information will be read by 5GC capable UEs)

Dedicated signaling may comprise:
NAS level information e.g., during 5G NAS registration, where the information is received from the 5GC over NG1 interface, (in this case UE can be connected to 5GC over gNB, eNB or non-3GPP), or
the NG-RAN (which may be LTE or gNB), such as via Radio Resource Control protocol, RRC, other than broadcast system information, such as for example when UE request ES fallback, or at initial RRC connection setup.
IMS signaling, when UE is attempting to register or initiate an IMS session, the IMS may indicate to the UE that ES is provided if connected over another network.

In another aspect, non-3GPP Access point, AP, such as WLAN AP may also provide the ES information, if the UE was originally connected to 5GC over WLAN.

The ES information indicate that 5GC does not support ES and indicate support of ES by the other network.

The other network/system/cell indicated may be either:
an EPC within the same PLMN or a different PLMN, or
a system such as EPS (LTE eNB and EPC) within the same PLMN or other PLMN, if the UE is connected to 5GC via gNB, or
a system such as EPS within the same PLMN or other PLMN if the UE is connected 5GC via eNB, but the eNB does not support connecting to EPC, hence UE has to select a different eNB or be redirected to another eNB that can connect to EPC;
a radio access node (cell) that is part of a system that supports Emergency Service, or
2G, 3G system, such as UMTS, GPRS that provides ES over circuit switched connectivity. If 2G, 3G system are the only networks that provide ES, the UE may obtain information about the frequencies of other RATs (e.g. 2G CS, 3G CS) that are candidate to provide ES based on the information provided in the 5G system information.

In another aspect, the ES information may provide one or more other networks/systems that support ES and may provide an order of priority that the UE may use to select the network or system in the event of Emergency. The priority may be provided on the basis of PLMNs associated to the network/system or based on the technology type. For instance, LTE/EPC has priority over 2G, 3G systems.

The information is provided to the UE while the UE is connected to 5GC to avoid the need for the UE to look for an LTE/EPC capable cell when ES is not supported.

Step 410: AT this step, the UE performs the step of determining the network to connect to for an emergency request based on the received ES information from the 5GC/SGS.

The UE may be required to suspend or release the connection to 5GC prior to sending the emergency request to the other network that supports ES. However, if the UE is able to support dual connectivity to two networks, it may request an emergency connection to the selected network that supports ES on the basis of the information received from 5GC or NG-RAN, while maintaining the connection to 5GC.

If the UE has received ES information indicating more than one network/systems supporting ES than 5GS within the same PLMN or different PLMNs, the UE may use the priority provided in the ES information to select the other network/system to fallback to for sending the emergency request.

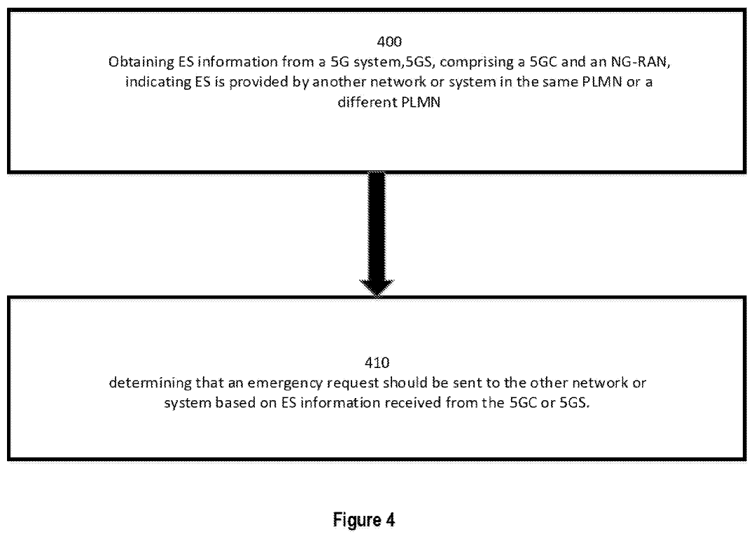

FIG. 5 illustrates an embodiment of a method in a network node in the 5G system for providing ES information to a UE connected or connecting to the 5G system when the 5G system does not support Emergency Services, ES. The network node provides the ES information in response to receiving an indication of an emergency connection or a connection that requires emergency handling.

The network node may be an AMF in 5GC, an NG RAN of a 5GS (e.g., gNB or eNB connected to 5GC), or a non-3GPP WLAN AP connected to 5GC. The network node may also be an IMS node connected to 5GC, such as for example a CSCF node.

Similar to the method illustrated in FIG. 4, the network node may broadcast the ES information or may use dedicated signaling such as NAS messages, RRC messages and even IMS signaling in order to provide the ES information to the UE.

Step 500: Depending on the type of network node performing the method as illustrated in FIG. 5, the network node executes the step 500 of determining for a UE connected to a 5GC/5GS that one or more other core networks/systems other than the 5GC or 5GS should provide Emergency services for the UE, where the other core network/system is within the same PLMN as the 5GC/5GS or in other PLMNs. The determining step may be in response to receiving a request indicating emergency from a UE or receiving a request for a service that requires emergency handling, e.g., a request for voice service.

Step 510: Similar to what is described above for the wireless device or UE, the method at the network node provides the step 510 of providing to the UE or wireless device with information on whether another network/system such as LTE/EPC (i.e., EPS) for the same PLMN or other PLMN supports ES and hence should be used instead by the UE to access the service. The information is provided to the UE while the UE is connected to 5GC to avoid the need for the UE to look for another cell connected to a system/network, e.g., an LTE/EPC that may not support ES.

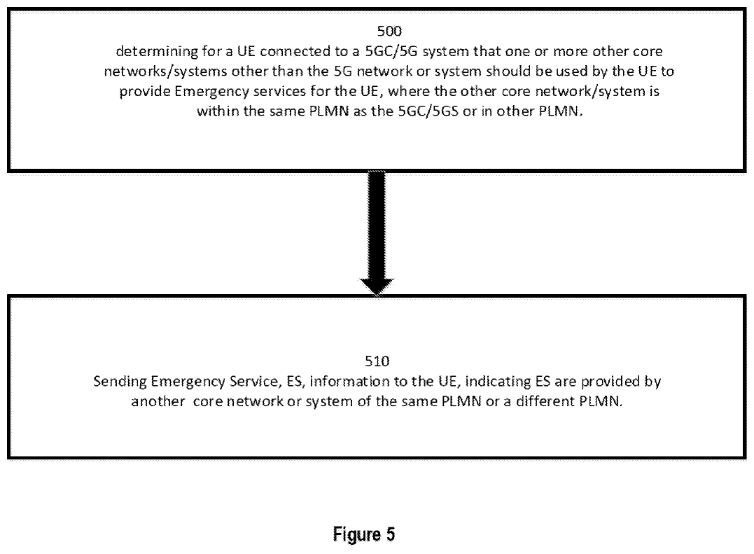

FIG. 6 is a block diagram of an exemplary WD/UE in accordance with some embodiments. The WD/UE includes one or more of a transceiver, processor, and memory. In some embodiments, the transceiver facilitates transmitting wireless or wired signals to and receiving wireless or wired signals from NG-RAN node (e.g., via transmitter(s) (Tx), receiver(s) (Rx) and antenna(s)). The processor executes instructions to provide some or all of the functionalities described above as being provided by the WD/UE, and the memory stores the instructions executed by the processor. In some embodiments, the processor and the memory form processing circuitry.

The processor may include any suitable combination of hardware to execute instructions and manipulate data to perform some or all of the described functions of the WD/UE, such as the functions of the WD/UE described above. In some embodiments, the processor may include, for example, one or more computers, one or more central processing units (CPUs), one or more microprocessors, one or more application specific integrated circuits (ASICs), one or more field programmable gate arrays (FPGAs) and/or other logic.

The memory is generally operable to store instructions, such as a computer program, software, an application including one or more of logic, rules, algorithms, code, tables, etc. and/or other instructions capable of being executed by a processor. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the processor of the WD/UE.

Other embodiments of WD/UE may include additional components beyond those shown in FIG. 5 that may be responsible for providing certain aspects of the wireless device's functionalities, including any of the functionalities described above and/or any additional functionalities (including any functionality necessary to support the solution described above). As just one example, the WD/UE may include input devices and circuits, output devices, and one or more synchronization units or circuits, which may be part of the processor. Input devices include mechanisms for entry of data into the WD/UE. For example, input devices may include input mechanisms, such as a microphone, input elements, a display, etc. Output devices may include mechanisms for outputting data in audio, video and/or hard copy format. For example, output devices may include a speaker, a display, etc.

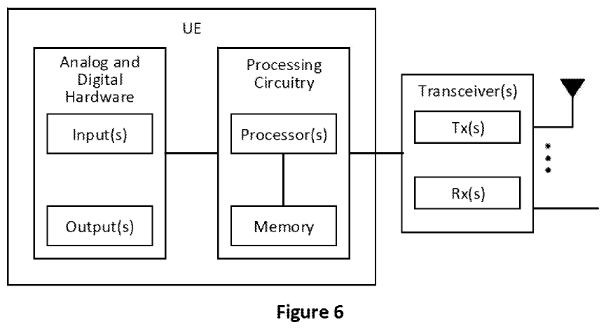

FIG. 7 is a block diagram of an exemplary wireless device, WD or UE in accordance with some embodiments. As illustrated, the WD/UE may comprise a series of modules (or units) 620, 630 configured to implement some or all of the functionalities of the WDUE described above.

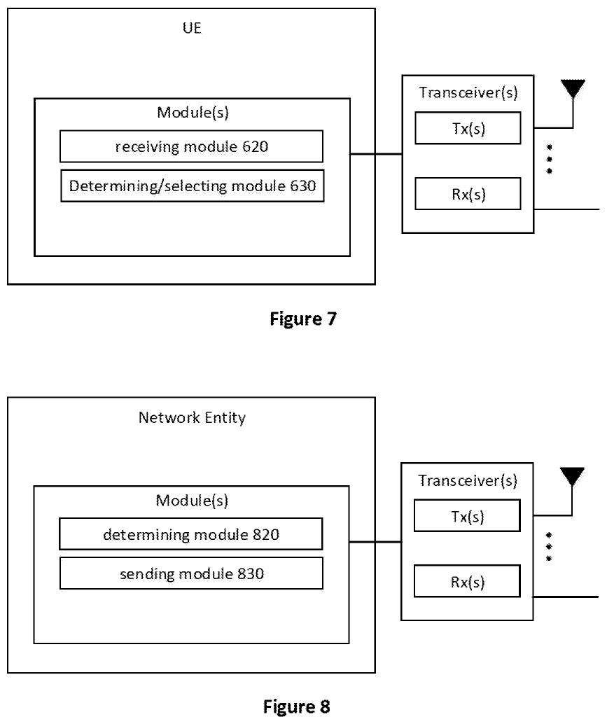

FIG. 8 is a block diagram of an exemplary Network entity (AMF, gNB, eNB or an IMS entity) in 5GS in accordance with some embodiments. As illustrated, the network entity may comprise a series of modules (or units) 820, 830 configured to implement some or all of the functionalities of the network entity in 5GS that provides the ES Emergency information for a UE when it does not support ES as described above. The transceiver in FIG. 8 is used when the network entity is either a gNB or an eNB or a non-3GPP AP.

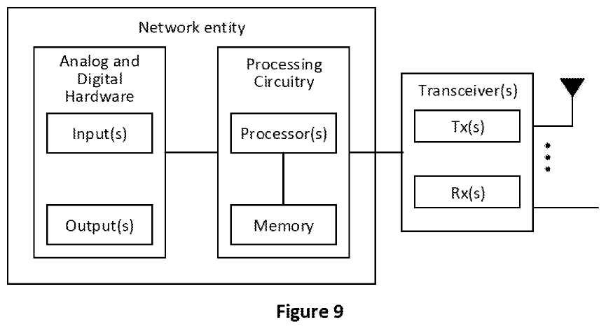

FIG. 9 is a block diagram of an exemplary Network Entity in 5GS in accordance with some embodiments. The Network Entity may be an AMF, gNB, eNB or IMS entity, depending on who is providing the ES information to the wireless device. The network entity of FIG. 8 includes one or more of a transceiver (if gNB or eNB), processor, and memory. In some embodiments, the transceiver facilitates transmitting wireless or wired signals to and receiving wireless or wired signals from NG-RAN node (e.g., via transmitter(s) (Tx), receiver(s) (Rx) and antenna(s)). The processor executes instructions to provide some or all of the functionalities described above as being provided by the network entity, and the memory stores the instructions executed by the processor. In some embodiments, the processor and the memory form processing circuitry.

The processor may include any suitable combination of hardware to execute instructions and manipulate data to perform some or all of the described functions of the network entity, such as the functions of the network entity described above. In some embodiments, the processor may include, for example, one or more computers, one or more central processing units (CPUs), one or more microprocessors, one or more application specific integrated circuits (ASICs), one or more field programmable gate arrays (FPGAs) and/or other logic.

The memory is generally operable to store instructions, such as a computer program, software, an application including one or more of logic, rules, algorithms, code, tables, etc. and/or other instructions capable of being executed by a processor. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the processor of the network entity.

Other embodiments of network entity may include additional components beyond those shown in FIG. 5 that may be responsible for providing certain aspects of the wireless device's functionalities, including any of the functionalities described above and/or any additional functionalities (including any functionality necessary to support the solution described above). As just one example, the r may include input devices and circuits, output devices, and one or more synchronization units or circuits, which may be part of the processor. Input devices include mechanisms for entry of data into the network entity. For example, input devices may include input mechanisms, such as a microphone, input elements, a display, etc. Output devices may include mechanisms for outputting data in audio, video and/or hard copy format. For example, output devices may include a speaker, a display, etc.

It will be appreciated that the various modules may be implemented as combination of hardware and/or software, for instance, the processor, memory and transceiver(s) of the network entity shown in FIG. 8. Some embodiments may also include additional modules to support additional and/or optional functionalities.

While not being limited thereto, some other example embodiments of the present disclosure are provided below.

### Embodiments

### Group A Embodiments

1. A method for determining a system for Emergency Services, ES performed by a UE/WD connected to a first core network/system of a Public Land Mobile Network, PLMN, and that does not support ES, the method comprising:
   receiving a message from the first core network/system containing ES information comprising information related to one or more other Core Networks/systems and/or or one or more cell that can connect to one or more other Core networks, wherein the one or more other core networks/systems are able to support Emergency services, wherein the one or more other core networks/systems and/or one or more cell belong to the same PLMNS or to other PLMNs; and
   determining that an emergency request should be sent to one of the one or more core networks/systems and/or one of the one or more cell as selected by the UE based on the ES information.
2. The method of embodiment 1 wherein the one or more other core network networks/systems and/or one or more cell are provided in an ordered priority.
3. The method of embodiment 1 wherein the first core network/system is a 5GC/5GS.
4. The method of embodiment 1, wherein the one or more core networks/systems comprise an EPC/EPS.
5. The method of embodiment 1 wherein the message is a broadcast 5G system information.
6. The method of embodiment 1 wherein the message is a broadcast LTE system information block type 1.
7. The method of embodiment 1 wherein the message is a NAS message sent over the NG1 interface.
8. The method of embodiment 1 wherein the message is an IMS message such as an IMS registration or an IMS Invite message.

### Group B Embodiments

9. A method performed by a network entity in a first core network/system of a PLMN for controlling access from a wireless device to another core network/system for Emergency Services, ES, the method comprising:
   determining for the wireless device connected to the first core network/system that one or more other core networks/systems other than the first core network/system should be used to provide Emergency services for the UE, where the one or more other core networks/systems is within the same PLMN as the first core network/system or in other PLMNs; and
   Sending a message to the wireless device comprising Emergency Services, ES, information, indicating that ES are provided by other one or more core networks/systems of the same PLMN or of different PLMN.
10. The method of embodiment 9 wherein the one or more other core networks/systems are provided in an ordered priority.
11. The method of embodiment 9 wherein the first core network/system is a 5GC/5GS.
12. The method of embodiment 9, wherein the one or more core networks/systems comprise an EPC/EPS.
13. The method of embodiment 9 wherein the message is a broadcast 5G system information.
14. The method of embodiment 9 wherein the message is a broadcast LTE system information block type 1.
15. The method of embodiment 9 wherein the message is a NAS message sent over the NG1 interface.
16. The method of embodiment 9 wherein the message is an IMS message such as an IMS registration or an IMS Invite message.

### Group C Embodiments

17. A computer program comprising instructions which, when executed on at least one processor, cause the at least one processor to carry out the method according to any one of Group A embodiments.
18. A carrier containing the computer program of embodiment 17, wherein the carrier is one of an electronic signal, an optical signal, a radio signal, or a computer readable storage medium.
19. A computer program comprising instructions which, when executed on at least one processor, cause the at least one processor to carry out the method according to any one of Group B embodiments.
20. A carrier containing the computer program of embodiment 19, wherein the carrier is one of an electronic signal, an optical signal, a radio signal, or a computer readable storage medium.
21. A wireless device for selecting a cell, the wireless device comprising:
   processing circuitry configured to perform any of the steps of any of the Group A embodiments; and
   power supply circuitry configured to supply power to the wireless device.
22. A user equipment (UE) for selecting a cell, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
23. A wireless device for selecting a cell, the wireless device comprising:
   a network interface;
   one or more processors; and
   memory comprising instructions executable by the one or more processors whereby the wireless device is operable to perform any of the steps of any of the Group A embodiments.
24. A wireless device for selecting a cell, the wireless device comprising:
   a receiving module operable receive a message from the first core network/system containing ES information comprising information related to one or more other Core Networks/systems and/or or one or more cell that can connect to one or more other Core networks, wherein the one or more other core networks/systems are able to support Emergency services, wherein the one or more other core networks/systems and/or one or more cell belong to the same PLMNS or to other PLMNs; and
   a determining module operable to determine that an emergency request should be sent to one of the one or more core networks/systems and/or one of the one or more cell as selected by the UE and based on the ES information.
25. A network entity for controlling access of a wireless device for Emergency services, ES, the network node comprising:
   a network interface;
   one or more processors; and
   memory comprising instructions executable by the one or more processors whereby the network entity is operable to perform any of the steps of any of the Group B embodiments.
26. A network entity of embodiment 25 wherein the network entity is an Access and Mobility management, AMF, entity.
27. A network entity of embodiment 25 wherein the network entity is a gNB or an eNB.
28. A network entity for controlling access of a wireless device for emergency services, ES, the network entity comprising:
   processing circuitry configured to perform any of the steps of any of the Group B embodiments;
   power supply circuitry configured to supply power to the wireless device.

The following acronyms are used throughout this disclosure.

| | |
|---|---|
| 3GPP | Third Generation Partnership Project |
| AP | Access Point |
| 5G | Fifth Generation |
| 5GC | 5G Core Network |
| 5GS | 5G System |
| ASIC | Application Specific Integrated Circuit |
| CN | Core Network |
| CPU | Central Processing Unit |
| DSP | Digital Signal Processor |
| eNB | Enhanced or Evolved Node B |
| EPC | Evolved Packet Core |
| EPS | Evolved Packet System |
| FPGA | Field Programmable Gate Array |
| gNB | Next Generation Node B |
| LTE | Long Term Evolution |
| NAS | Non-Access Stratum |
| NG | Next Generation |
| RAN | Radio Access Network |
| RRC | Radio Resource Control |
| SI | System Information |
| SIB1 | SI block 1 |
| UE | User Equipment |
| WD | Wireless device |

Those skilled in the art will recognize improvements and modifications to the embodiments of the present disclosure. All such improvements and modifications are considered within the scope of the concepts disclosed herein.

### REFERENCES

1. 3GPP TS 36.331 “Radio Resource Protocol, Release 15.
2. 3GPP TS 23.401 “Evolved Universal Terrestrial Radio Access Network (E-UTRAN) access (Release 15)

1. A method of obtaining emergency service, ES, by a wireless device connecting to a first core network or system that does not support ES, the method comprising:
receiving from a first core network or system a message comprising ES information indicating at least one of
one or more other core network or system or
one or more radio access node capable of connecting to one or more other core network,
that is able to support ES, wherein the at least one or more other core network or system or the one or more radio access node is in the same Public Land Mobile Network, PLMN, as the first core network or system or belong to one or more other PLMN; and
in accordance with the ES information, sending, to the at least one of the one or more other core network or system, or one of the one or more radio access node, a connection request indicating a request for emergency services.

2. The method of claim 1 wherein the at least one of the one or more other core network or system or the one or more radio access node is provided in an ordered priority.

3. The method of claim 1 wherein the first core network or system is a fifth generation core network, 5GC or 5G System, 5GS.

4. The method of claim 1, wherein the one or more other core network or system comprise an Evolved Packet Core, EPC, or Evolved Packet System, EPS.

5. The method of claim 1, wherein the radio access node is either a 5G radio access node or a Long-Term Evolution radio access node or a non-third generation partnership, non-3GPP, access node.

6. The method of claim 1 wherein the message is a broadcast 5G system information.

7. The method of claim 1 wherein the message is a broadcast Long-Term Evolution, LTE, system information block type 1.

8. The method of claim 1 wherein the message is a Non-Access Stratum, NAS message received from the 5GC.

9. The method of claim 1 wherein the message is an Internet Protocol Multimedia Subsystem, IMS, message such as an IMS registration or an IMS INVITE message.

10. A method of controlling access of a wireless device for Emergency Services, ES, performed at a network entity in a first core network or system that does not support ES, the method comprising:
determining for the wireless device at least one of
one or more other core network or system or
one or more radio access node capable of connecting to one or more other core network,
that is able to support ES, wherein the at least one or more other core network or system or the one or more radio access node is in the same Public Land Mobile Network, PLMN, as the first core network or system or in one or more other PLMN; and
sending to the wireless device a message comprising ES information indicating that ES is provided by the at least one of the one or more other core network or system or the one or more radio access node capable of connecting to one or more other core network.

11. The method of claim 10 wherein the at least one or more other core network or system is provided in an ordered priority.

12. The method of claim 10 wherein the first core network or system is a fifth generation core network, 5GC or 5G System, 5GS.

13. The method of claim 10, wherein the one or more other core network or system comprise an Evolved Packet Core, EPC, or an Evolved Packet System, EPS.

14. The method of claim 10 wherein the message is a broadcast 5G system information.

15. The method of claim 10 wherein the message is a broadcast Long Term Evolution, LTE, system information block type 1.

16. The method of claim 10 wherein the message is a Non-Access Stratum, NAS message.

17. The method of claim 10 wherein the message is an Internet Protocol Multimedia Subsystem, IMS, message.

18. The method of claim 17 wherein the IMS message is at least one of an IMS registration or an IMS INVITE message.

19. A computer program comprising instructions which, when executed on at least one processor, cause the at least one processor to carry out the method according to any one of method claims 1-9.

20. A carrier containing the computer program of claim 19, wherein the carrier is one of an electronic signal, an optical signal, a radio signal, or a computer readable storage medium.

21. computer program comprising instructions which, when executed on at least one processor, cause the at least one processor to carry out the method according to any one of claims 10-18.

22. A carrier containing the computer program of claim 21, wherein the carrier is one of an electronic signal, an optical signal, a radio signal, or a computer readable storage medium.

23. A wireless device comprising:
a processing circuitry configured to perform any of the steps of any of the method claims 1 to 9; and
a power supply circuitry configured to supply power to the wireless device.

24. A user equipment, UE, comprising:
an antenna configured to send and receive wireless signals;
a radio front-end circuitry connected to the antenna and to processing circuitry, and configured to condition signals communicated between the antenna and the processing circuitry;
the processing circuitry being configured to perform any of the steps of any of the method claims 1-9;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

25. A wireless device comprising:
a network interface;
one or more processors; and
memory comprising instructions executable by the one or more processors whereby the wireless device is operable to perform any of the steps of any of method claims 1-9.

26. A wireless device comprising:
a receiving module operable to receive from a first core network or system a message comprising Emergency Service, ES, information indicating at least one of
one or more other core network or system or
one or more radio access node capable of connecting to one or more other core network,
that is able to support ES, wherein the at least one or more other core network or system or the one or more radio access node is in the same Public Land Mobile Network, PLMN, as the first core network or system or belong to one or more other PLMN; and
a determining module operable to, based on the ES information, determine a core network or system or radio access node to send a connection request indicating ES.

27. A network entity for controlling access of a wireless device for Emergency Services, ES, the network node comprising:
a network interface;
one or more processors; and
a memory comprising instructions executable by the one or more processors whereby the network entity is operable to perform any of the steps of any of the method claims 10-18.

28. A network entity of claim 27 wherein the network entity is an Access and Mobility management, AMF, entity.

29. A network entity of claim 27 wherein the network entity is a Fifth Generation NodeB or a Long-Term Evolution NodeB.
